(19) United States
(12) Patent Application Publication
(10) Pub. No.: US 2022/0205819 A1
(43) Pub. Date: Jun. 30, 2022

(54) AIR SEPARATION CONTROL SYSTEM AND CONTROL METHOD

(71) Applicant: L'Air Liquide, Societe Anonyme pour l'Etude et l?Exploitation des Procedes Georges Claude, Paris (FR)

(72) Inventors: Jianwei LI, Zhejiang (CN); Rui LIU, Zhejiang (CN); Fei GAO, Zhejiang (CN)

(73) Assignee: L'Air Liquide, Societe Anonyme pour l'Etude et l?Exploitation des Procedes Georges Claude, Paris (FR)

(21) Appl. No.: 17/558,356

(22) Filed: Dec. 21, 2021

(30) Foreign Application Priority Data
Dec. 30, 2020 (CN) 202011609316.2

(51) Int. Cl. G01D 21/02; B01D 46/02; B01D 46/44

(52) U.S. Cl. CPC G01D 21/02; B01D 46/448; B01D 46/02

(57) ABSTRACT

The present invention discloses an air separation control system and control method comprising: multiple air separation plants for air separation; multiple local controllers, respectively corresponding to the multiple air separation plants; each local controller being located locally at the air separation plant corresponding thereto, and being in communicative connection with the corresponding air separation plant, for the purpose of locally controlling the air separation plant; and a remote optimization controller, in communicative connection with each local controller separately; the remote optimization controller at least comprising a communication module, a prediction module and a control module; the remote optimization controller being able to perform data exchange with and predictive control of the multiple air separation plants simultaneously via the local controllers. The present invention controls multiple air separation plants located at different locations via a remote optimization controller, thus reducing the professional competence requirements placed on operators; during optimization, the relationship between multiple air separation plants can be considered as a whole, so that the air separation plants operate smoothly.

### CROSS REFERENCE TO RELATED APPLICATIONS

This application claims the benefit of priority under 35 U.S.C. § 119 (a) and (b) to Chinese patent application No. CN20201160931.2, filed Dec. 30, 2020 and published as CN 112783034 on May 11, 2021, the entire contents of which are incorporated herein by reference.

### TECHNICAL FIELD OF THE INVENTION

The present invention relates to the field of control systems, in particular to an air separation control system and control method.

### BACKGROUND OF THE INVENTION

Adjustment and optimization of the operating process of an air separation plant generally rely on an operator to adjust a local control system in communicative connection with the air separation plant or an advanced control system in a local computer; thus, both operation and maintenance of the air separation plant need to be carried out locally at the air separation plant. Optimization, upgrading and programming of the local control system or the advanced control system in the local computer also need to be performed locally at the air separation plant. This places higher requirements on the ability of the local operator to adjust the local control system or advanced control system. Multiple air separation plants might be located at different sites, and in order to ensure the operational effectiveness and operating safety of the air separation plants, a professional operator must be provided at each air separation plant. However, due to a shortage of operators or a low level of technical ability amongst operators, the adjustment and optimization of air separation plant operation cannot meet actual needs.

The intellectual property information stored in the local control system or the advanced control system in the local computer is also at risk of being leaked, thus causing losses.

### SUMMARY OF THE INVENTION

The objective of certain embodiments of the present invention is to provide an air separation control system and control method, wherein a remote optimization controller is provided, so as to intervene in and optimize the operation of multiple air separation plants.

In order to achieve the above objective, certain embodiments of the present invention provides an air separation control system that can include: multiple air separation plants for air separation; multiple local controllers, corresponding to the multiple air separation plants; each local controller being located locally at the air separation plant corresponding thereto, and being in communicative connection with the corresponding air separation plant, for the purpose of controlling the air separation plant; and a remote optimization controller, in communicative connection with each local controller separately.

In preferred embodiments, the remote optimization controller can include a communication module, a prediction module and a control module; and the remote optimization controller being able to perform data exchange with and predictive control of the multiple air separation plants simultaneously via the local controllers.

Preferably, the remote optimization controller is provided at a fixed location, being situated at a location local to any one air separation plant or a location different from that of each of the multiple air separation plants.

Preferably, the remote optimization controller determines a controlled variable, an operating variable and a disturbance variable according to an optimization target parameter of each air separation plant, and establishes predictive control models separately on this basis.

Preferably, the remote optimization controller further comprises a data storage module for storing operating data; the operating data comprises currently collected real-time data and historical data of all of the air separation plants.

Preferably, the communication module is configured to be in communicative connection with each local controller separately, receive the currently collected real-time data, and send an operating instruction to the local controller;

the prediction module predicts a value of the controlled variable according to the predictive control model, historical data and real-time data, adjusts the operating variable according to the value, and provides feedback to the control module;

the control module generates an operating instruction for regulating air separation plant operation according to the feedback of the prediction module;

the control module sends the operating instruction to provide feedback to the local controller at the air separation plant via the communication module, and adjusts a value of the operating variable via the local controller; by adjusting the value of the operating variable, the controlled variable is kept within a preset range and as close to an optimal value as possible at the current time and for a future period of time; at the same time, a change in value of the disturbance variable will cause the predicted value of the controlled variable to change, and in order to ensure that the controlled variable is always within the preset range, the operating variable will be adjusted correspondingly.

Preferably, the controlled variable comprises any one or more of the following: temperature, pressure, flow rate, liquid level, and components.

Preferably, the optimization target parameter comprises any one or more of the following: extraction rate of oxygen, extraction rate of nitrogen, extraction rate of argon, gaseous oxygen product purity, gaseous nitrogen product purity and gaseous argon product purity.

Preferably, the air separation plant at least comprises a high-pressure column, a low-pressure column, a crude argon column, an air compressor and an air expander.

Preferably, the controlled variable comprises an oxygen content at an argon fraction extraction port of the low-pressure column, an oxygen content in a middle region of the crude argon column, a temperature in front of the air expander, and an argon component, etc.; the operating variable comprises a gaseous oxygen product flow rate, a total air flow rate into the high-pressure column, a high-pressure air flow rate, an expanded air quantity, and a crude argon liquid flow rate; and the disturbance variable comprises a liquid nitrogen flow rate, a medium-pressure nitrogen gas flow rate, a gaseous oxygen product flow rate, and a gaseous argon product flow rate.

Preferably, the remote optimization controller can adjust the predictive control model according to historical data and real-time data.

Preferably, a safe mode is included: the preset range of the controlled variable is provided in the data storage module; the remote optimization controller breaks the communication connection between the remote optimization controller and the local controller when the controlled variable exceeds the preset range, and the local controller directly controls the air separation plant.

Preferably, the air separation control system can switch operation between an optimized mode and a non-optimized mode;

in the optimized mode, the local controller collects the operating data, and regulates the operation of the air separation plant according to an operating instruction provided by the remote optimization controller;

in the non-optimized mode, the local controller blocks an operating instruction coming from the remote optimization controller, and the local controller independently regulates the operation of the air separation plant locally.

Preferably, after receiving an operating instruction of the remote optimization controller, the local controller switches to the non-optimized mode in which the local controller independently regulates the operation of the air separation plant locally;

alternatively, the local controller regulates the operation of the air separation plant according to an operating instruction provided by the remote optimization controller, and continues to collect operating data of the air separation plant and send it to the remote optimization controller for further optimization; and the optimized mode is executed cyclically until it is switched to the non-optimized mode in which the local controller independently regulates the operation of the air separation plant locally.

Preferably, regulating the operation of the air separation plant at least comprises controlling a start operation, a stop operation, all control loops and a safety interlock device.

Preferably, the start operation, stop operation, all control loops and safety interlock device of the air separation plant are kept at a local level, and are controlled by the local controller.

Preferably, the remote optimization controller provides an operating instruction according to operating data collected by one or more local controllers; the remote optimization controller feeds the operating instruction back to the local controller that provided operating data thereto, or feeds the operating instruction back to all of the local controllers in communicative connection therewith.

Certain embodiments of the present invention also provide a control method for an air separation control system, suitable for the air separation control system described, and comprising: a remote optimization controller determining a controlled variable, an operating variable and a disturbance variable according to an optimization target parameter, and establishing a predictive control model; receiving currently collected real-time data from a local controller, while a data storage module stores operating data; predicting a value of the controlled variable according to the predictive control model, historical data and real-time data, and providing feedback to a control module; the control module generating an operating instruction for regulating air separation plant operation according to feedback of a prediction module; the operating instruction being fed back to the local controller at the air separation plant via the communication module, and a value of the operating variable being adjusted via the local controller; by adjusting the value of the operating variable, the controlled variable is kept within a preset range and as close to an optimal value as possible at the current time and for a future period of time; at the same time, a change in value of the disturbance variable will cause the predicted value of the controlled variable to change, and in order to ensure that the controlled variable is always within the preset range, the operating variable will be adjusted correspondingly; regulating the operation of the air separation plant according to the operating instruction.

The beneficial effects of certain embodiments of the present invention are as follows:

The air separation control system provided by certain embodiments of the present invention controls multiple air separation plants located at different positions via a remote optimization controller, thus reducing the professional competence requirements placed on operators; while adjusting and optimizing each air separation plant, the remote optimization controller also performs self-optimization of the predictive control model, thus achieving effective coupling of artificial intelligence to the air separation plants; during optimization, the relationship between multiple air separation plants can be considered as a whole, so that the air separation plants operate smoothly. At the same time, intellectual property information is stored in the remote optimization controller with a high level of confidentiality; this can reduce the risk of information leakage and advantageously protects the intellectual property information of the air separation plants.

### BRIEF DESCRIPTION OF THE DRAWINGS

FIG. 1 is a schematic diagram of the air separation control system of the present invention.

FIG. 2 is a flow chart of the control method for the air separation control system of the present invention.

### DETAILED DESCRIPTION OF THE INVENTION

The technical solution of the present invention will be clearly and completely described below in conjunction with the accompanying drawings. Obviously, the described embodiments are some of the embodiments of the present invention, rather than all of the embodiments. Based on the embodiments of the present invention, all other embodiments obtained by those of ordinary skill in the art without creative work shall fall within the protection scope of the present invention.

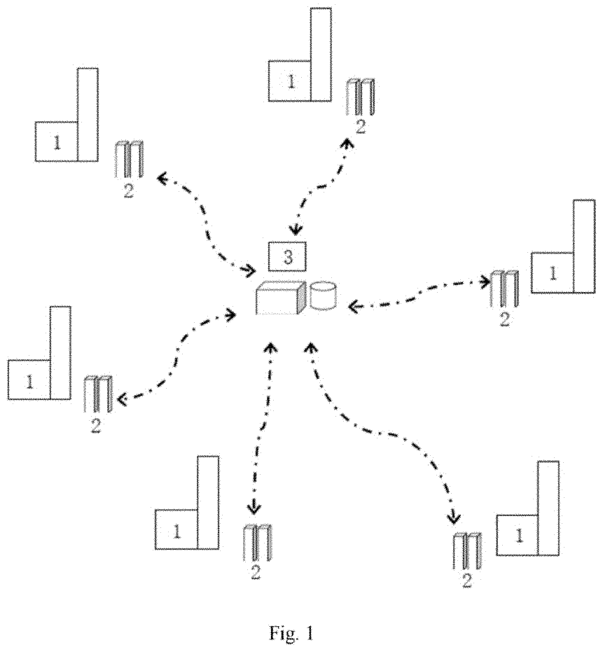

As shown in FIG. 1, the air separation control system provided by certain embodiments of the present invention comprises multiple air separation plants for air separation; the air separation plant at least comprises a high-pressure column, a low-pressure column, a crude argon column, an air compressor and an air expander. Multiple local controllers correspond to the multiple air separation plants; each local controller is located locally at the air separation plant corresponding thereto, and is in communicative connection with the corresponding air separation plant, for the purpose of controlling the air separation plant; optionally, the local controller can be a DCS (distributed control system)/PLC (programmable logic controller)/SIS (safety instrumented control system). A remote optimization controller is in communicative connection with each local controller separately; the remote optimization controller can perform data exchange with and predictive control of the multiple air separation plants simultaneously via the local controller; and the remote optimization controller is provided at a fixed location, being situated at a location local to a certain air separation plant, or a location different from that of each of the multiple air separation plants.

The remote optimization controller comprises a communication module, a prediction module, a control module and a data storage module. The prediction module first determines controlled variables, operating variables and disturbance variables according to optimization target parameters of each air separation plant, and establishes predictive control models separately on this basis; moreover, the predictive control model is capable of continuous self-adjustment according to historical data and real-time data.

The controlled variables are process parameters in the air separation plants that are required to be kept within a preset range; the operating variables are process parameters that are operated by the local controllers and used to overcome the influence of interference so as to keep the controlled variables within the preset range and as close as possible to optimal values; and the disturbance variables are factors that are not operating variables, but act on the air separation plants and cause the controlled variables to change. The controlled variables include any one or more of the following: temperature, pressure, flow rate, liquid level, and components.

The communication module is in communicative connection with each local controller separately, and receives values of the controlled variables, operating variables and disturbance variables collected in real time by the local controllers as real-time data, which is transmitted to the remote optimization controller and stored in the data storage module. The predictive control model is based on an algorithm, and predicts values of the controlled variables according to the real-time data collected on this occasion and historical data collected previously, adjusts the operating variables according to these values, and feeds the controlled variables back to the control module.

The control module generates operating instructions for regulating the operation of the air separation plants according to the feedback of the prediction module, sends the operating instructions to the local controllers via the communication module, and adjusts the values of the operating variables via the local controllers. By adjusting the values of the operating variables, the controlled variables are kept within the preset range and as close to the optimal values as possible at the current time and for a future period of time. At the same time, changes in the values of the disturbance variables will cause the predicted values of the controlled variables to change.

In order to ensure that the controlled variables are always within the preset range, the operating variables will be adjusted correspondingly. The data storage module is used to store operating data, which includes the real-time data collected on this occasion by the communication module and the historical data collected previously. The preset range of the controlled variables is also provided in the data storage module.

In some embodiments, the optimization target parameters include any one or more of the following: oxygen extraction rate, nitrogen extraction rate, argon extraction rate, gaseous oxygen product purity, gaseous nitrogen product purity, and gaseous argon product purity. The controlled variables include the oxygen content at the argon fraction extraction port of the low-pressure column, oxygen content in a middle region of the crude argon column, temperature in front of the air expander, and argon component, etc.; the operating variables include the gaseous oxygen product flow rate, total air flow rate into the high-pressure column, high-pressure air flow rate, expanded air quantity, and crude argon liquid flow rate; and the disturbance variables include the liquid nitrogen flow rate, medium-pressure nitrogen gas flow rate, gaseous oxygen product flow rate, and gaseous argon product flow rate.

The modes of operation of the air separation control system provided by certain embodiments of the present invention include an optimized mode and a non-optimized mode; the air separation control system can switch operation between the optimized mode and the non-optimized mode.

In the optimized mode, the local controllers collect the operating data, and regulate the operation of the air separation plants according to the operating instructions provided by the remote optimization controller.

In the non-optimized mode, the local controllers block the operating instructions coming from the remote optimization controller, and the local controllers independently regulate the operation of the air separation plants locally. In some embodiments, after receiving an operating instruction of the remote optimization controller, the local controller switches to the non-optimized mode in which the local controller independently regulates the operation of the air separation plant locally.

In other embodiments, the local controllers regulate the operation of the air separation plants according to the operating instructions provided by the remote optimization controller, and continue to collect operating data of the air separation plants and send it to the remote optimization controller for further optimization; and the optimized mode is cyclically executed until it is switched to the non-optimized mode in which the local controller independently regulates the operation of the air separation plant locally.

When the control system for the air separation plants is operating in the optimized mode, the control module is allowed to read the data storage module. When a controlled variable exceeds the preset range, the communication connection between the remote optimization controller and the local controller is broken, and the optimized mode is switched to a safe mode, with the local controller directly controlling the air separation plant.

In some embodiments, regulating the operation of the air separation plants at least includes controlling a start operation, a stop operation, all control loops, and a safety interlock device. The start operation, stop operation, all control loops and safety interlock device are kept at the local level, controlled by the local controller.

In some embodiments, the remote optimization controller provides operating instructions according to the operating data collected by one or more local controllers; the remote optimization controller feeds the operating instructions back to the local controller that provided the operating data thereto, or feeds the operating instructions back to all of the local controllers in communicative connection therewith.

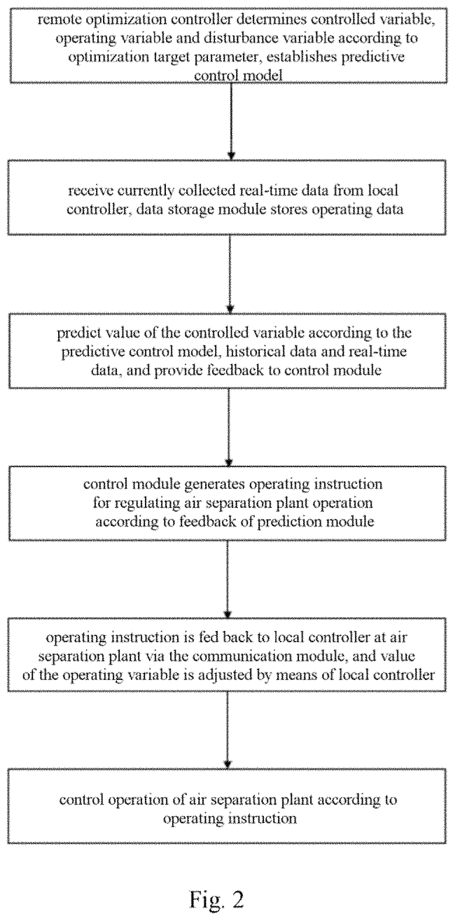

As shown in FIG. 2, a control method for the air separation control system of the present invention is as follows:

The remote optimization controller determines the controlled variables, operating variables and disturbance variables according to the optimization target parameters, and establishes a predictive control model.

Currently collected real-time data is received from the local controllers, and the data storage module stores operating data at the same time.

The values of the controlled variables are predicted according to the predictive control model, historical data and real-time data, and fed back to the control module.

The control module generates operating instructions for regulating the operation of the air separation plants according to the feedback of the prediction module; the operating instruction being fed back to the local controller at the air separation plant via the communication module, and a value of the operating variable being adjusted via the local controller; by adjusting the value of the operating variable, the controlled variable is kept within a preset range and as close to an optimal value as possible at the current time and for a future period of time; at the same time, a change in value of the disturbance variable will cause the predicted value of the controlled variable to change, and in order to ensure that the controlled variable is always within the preset range, the operating variable will be adjusted correspondingly.

The operation of the air separation plant is regulated according to the operating instructions.

In summary, the air separation control system and control method as provided by certain embodiments of the present invention control multiple air separation plants located at different locations via a remote optimization controller, thus reducing the professional competence requirements placed on operators; during optimization, the relationship between multiple air separation plants can be considered as a whole, so that the air separation plants operate smoothly. At the same time, intellectual property information is stored in the remote optimization controller, so the risk of information leakage can be reduced.

Although the content of the present invention has been presented in detail by means of the preferred embodiments above, it should be recognized that the description above should not be considered as a limitation of the present invention. Various amendments and substitutions to the present invention will be apparent after perusal of the above content by those skilled in the art. Thus, the scope of protection of the present invention should be defined by the attached claims.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

In the figures:

1—air separation unit,

2—local controller,

3—remote optimization controller.

We claim:

1. Air separation control system comprising:
multiple air separation plants configured to separate air via cryogenic distillation;
multiple local controllers, corresponding to the multiple air separation plants; each local controller being located locally at the air separation plant corresponding thereto, and being in communicative connection with the corresponding air separation plant, for the purpose of controlling the air separation plant; and
a remote optimization controller, in communicative connection with each local controller separately;
wherein the remote optimization controller comprises a communication module, a prediction module and a control module;
wherein the remote optimization controller is configured to perform data exchange with and predictive control of the multiple air separation plants simultaneously via the local controllers.

2. The air separation control system according to claim 1, wherein the remote optimization controller is provided at a fixed location, being situated at a location local to any one air separation plant or a location different from that of each of the multiple air separation plants.

3. The air separation control system according to claim 1, wherein the remote optimization controller determines a controlled variable, an operating variable and a disturbance variable according to an optimization target parameter of each air separation plant, and establishes predictive control models separately on this basis.

4. The air separation control system according to claim 3, wherein the remote optimization controller further comprises a data storage module for storing operating data; the operating data comprises currently collected real-time data and historical data of all of the air separation plants.

5. The air separation control system according to claim 4, wherein the communication module is configured to be in communicative connection with each local controller separately, receive the currently collected real-time data, and send an operating instruction to the local controller;
the prediction module predicts a value of the controlled variable according to the predictive control model, historical data and real-time data, adjusts the operating variable according to the value, and provides feedback to the control module;
the control module generates an operating instruction for regulating air separation plant operation according to the feedback of the prediction module;
the control module sends the operating instruction to provide feedback to the local controller at the air separation plant via the communication module, and adjusts a value of the operating variable via the local controller; by adjusting the value of the operating variable, the controlled variable is kept within a preset range and as close to an optimal value as possible at the current time and for a future period of time; at the same time, a change in value of the disturbance variable will cause the predicted value of the controlled variable to change, and in order to ensure that the controlled variable is always within the preset range, the operating variable will be adjusted correspondingly.

6. The air separation control system according to claim 3, wherein the controlled variable comprises any one or more of the following: temperature, pressure, flow rate, liquid level, and components.

7. The air separation control system according to claim 3, wherein the optimization target parameter comprises any one or more of the following: extraction rate of oxygen, extraction rate of nitrogen, extraction rate of argon, gaseous oxygen product purity, gaseous nitrogen product purity and gaseous argon product purity.

8. The air separation control system according to claim 6, wherein the air separation plant at least comprises a high-pressure column, a low-pressure column, a crude argon column, an air compressor and an air expander.

9. The air separation control system according to claim 8, wherein the controlled variable comprises an oxygen content at an argon fraction extraction port of the low-pressure column, an oxygen content in a middle region of the crude argon column, a temperature in front of the air expander, and an argon component, etc.; the operating variable comprises a gaseous oxygen product flow rate, a total air flow rate into the high-pressure column, a high-pressure air flow rate, an expanded air quantity, and a crude argon liquid flow rate; and the disturbance variable comprises a liquid nitrogen flow rate, a medium-pressure nitrogen gas flow rate, a gaseous oxygen product flow rate, and a gaseous argon product flow rate.

10. The air separation control system according to claim 4, wherein the remote optimization controller can adjust the predictive control model according to historical data and real-time data.

11. The air separation control system according to claim 5, further comprising a safe mode: the preset range of the controlled variable is provided in the data storage module; the remote optimization controller breaks the communication connection between the remote optimization controller and the local controller when the controlled variable exceeds the preset range, and the local controller directly controls the air separation plant.

12. The air separation control system according to claim 1, wherein the air separation control system can switch operation between an optimized mode and a non-optimized mode;
in the optimized mode, the local controller collects the operating data, and regulates the operation of the air separation plant according to an operating instruction provided by the remote optimization controller;
in the non-optimized mode, the local controller blocks an operating instruction coming from the remote optimization controller, and the local controller independently regulates the operation of the air separation plant locally.

13. The air separation control system according to claim 12, wherein after receiving an operating instruction of the remote optimization controller, the local controller switches to the non-optimized mode in which the local controller independently regulates the operation of the air separation plant locally.

14. The air separation control system according to claim 12, wherein the local controller is configured to regulate the operation of the air separation plant according to an operating instruction provided by the remote optimization controller, and continues to collect operating data of the air separation plant and send the operating data to the remote optimization controller for further optimization; and the optimized mode is executed cyclically until it is switched to the non-optimized mode in which the local controller independently regulates the operation of the air separation plant locally.

15. The air separation control system according to claim 12, wherein regulating the operation of the air separation plant at least comprises controlling a start operation, a stop operation, all control loops and a safety interlock device.

16. The air separation control system according to claim 15, wherein the start operation, stop operation, all control loops and safety interlock device of the air separation plant are kept at a local level, and are controlled by the local controller.

17. The air separation control system according to claim 5, wherein the remote optimization controller provides an operating instruction according to operating data collected by one or more local controllers; the remote optimization controller feeds the operating instruction back to the local controller that provided operating data thereto, or feeds the operating instruction back to all of the local controllers in communicative connection therewith.

18. A control method for air separation control system, suitable for control of the air separation system according to claim 1, the method comprising the steps of:
providing a remote optimization controller that is configured to determine a controlled variable, an operating variable and a disturbance variable according to an optimization target parameter, and establishing a predictive control model;
receiving currently collected real-time data from a local controller, while a data storage module stores operating data;
predicting a value of the controlled variable according to the predictive control model, historical data and real-time data, and providing feedback to a control module;
generating an operating instruction for regulating air separation plant operation according to feedback of a prediction module using the control module;
the operating instruction being fed back to the local controller at the air separation plant via the communication module, and a value of the operating variable being adjusted via the local controller; by adjusting the value of the operating variable, the controlled variable is kept within a preset range and as close to an optimal value as possible at the current time and for a future period of time; at the same time, a change in value of the disturbance variable will cause the predicted value of the controlled variable to change, and in order to ensure that the controlled variable is always within the preset range, the operating variable will be adjusted correspondingly; and
regulating the operation of the air separation plant according to the operating instruction.
